(19) United States
(12) Patent Application Publication
(10) Pub. No.: US 2017/0012772 A1
(43) Pub. Date: Jan. 12, 2017

(54) Method and device for generating a secret key

(71) Applicant: Robert Bosch GmbH, Stuttgart (DE)

(72) Inventor: Andreas MUELLER, Waiblingen (DE)

(21) Appl. No.: 14/923,003

(22) Filed: Oct. 26, 2015

(30) Foreign Application Priority Data
Oct. 28, 2014 (DE) 10 2014 221 893.4

(51) Int. Cl. H04L 9/08; H04L 12/26

(52) U.S. Cl. CPC H04L 9/0875; H04L 43/0876

(57) ABSTRACT

In a method for generating a secret key, a first node which is connected via a transmission channel to a second node measures a sequence of physical channel parameters of the transmission channel within a predefined time window, determines for multiple predefined code words a distance of each code word from the sequence, selects a particular code word from the multiple code words which has the shortest distance from the sequence, and adjusts a bit sequence which is assigned to the selected code word with the second node via the transmission channel.

### BACKGROUND OF THE INVENTION

1. Field of the Invention

The present invention relates to a device and a method for generating a secret key.

2. Description of the Related Art

A symmetric cryptographic system is a cryptographic system in which, in contrast to an asymmetric cryptographic system, all (legitimate) participants involved use the same key. The utilization of one and the same key for encrypting and decrypting data for computing and checking the message authentication codes, etc., involves that prior to any encrypted exchange the key itself must initially be distributed. However, since the safety of the entire method depends on the secrecy of the key, conventional approaches in most cases provide for the key exchange via a secure channel. This may take place, in particular, by manually introducing the key into the respective participants, e.g., by entering a password from which the actual key may then be deduced.

However, the key exchange via unsecure channels, which is known in cryptography as the “key distribution problem,” still presents a challenge to those skilled in the art. To solve this problem, the related art offers approaches such as the known Diffie-Hellman key exchange or the so-called hybrid encryption process which enable the exchange of symmetric keys by incorporating asymmetric protocols.

In the recent past, cryptographic systems are, however, increasingly discussed which deflect the problem of key establishment from the application layer of the OSI reference model to its bit transmission layer (physical layer, PHY). Approaches of this type are applied in the still young field of cyber-physical systems which distinguish themselves by predominantly using wireless and thus inherently unsafe communication channels.

Corresponding methods provide that each of the participating parties deduces a key from the physical characteristics of the channel which connects them in such a way that the keys generated in this way match without making it necessary for concrete parts of the key to be transmitted. U.S. Pat. No. 7,942,324 B1 provides a method of this type, as an example.

One weak point of methods of this type is their susceptibility to noise effects, interferences, and other local disturbances. Measurement time or measurement frequency deviations of the participating nodes sometimes also impair the reciprocity of the channel. Imponderables of this type may require a complex adjustment of the keys generated by the two nodes.

### BRIEF SUMMARY OF THE INVENTION

One advantage of this approach is the robust generation of an initial bit string for key generation, since not only a single measured value of the contemplated physical property is quantized, but an entire sequence of such measured values. With the aid of this approach, the influence of individual deviations, due to noise spikes or temporarily high interference, for example, may, in particular, be reduced.

As a result, the second node is also able to measure a sequence of the physical channel parameters within the time window, ascertain for this sequence the distance of the sequence based on a suitable metric for each code word of a certain code book, and select from the code words that particular code word which has the shortest distance from the sequence. The adjustment of the initial bit sequences ascertained by the first and the second nodes subsequently takes place jointly by the two nodes. This mirror-inverted interaction of the participating nodes makes it possible to create both nodes according to a common functionality, thus significantly reducing the costs per item of appropriate devices.

Furthermore, the first and the second nodes may each store a matching code book which includes the code words and assigns each code word the initial bit sequence to be used for the key adjustment. In this way, a sequence which, for example, includes almost identical channel parameters due to a lack of variability of the channel may be quantized to only one or a few bits, whereas a sequence including many different channel parameters is quantized to a larger number of bits. This is made possible, in particular, in that different code words do not necessarily always have to be assigned to the same number of bits. The number of bits per code word may rather be established as a function of the occurrence or selection probability of a code word. Thus, the possibility of integrating a type of source coding into the process de facto exists for the purpose of increasing or maximizing the effective entropy per initial bit string generated.

Furthermore, the distance maybe determined with the aid of numerous suitable distance metrics. The Euclidian distance, a Minkowski distance of predefined order, a chordal distance, or a Chebyshev distance, in particular, come into consideration. In this way, it is possible to further reduce the probability of unequal initial bit sequences for the participating nodes.

In addition to the previously mentioned points, however, the above-described method in particular also enables a dynamic adaptation of the initial key generation to the existing ambient and boundary conditions. This not only includes an adaptive optimization of the generated initial bit strings, but it also allows for aspects such as available computing and storing resources or energy budgets to be taken into consideration. As a function of these aspects, the first and the second nodes may, for example, select the same code book from multiple matching code books, which are stored on both nodes, prior to determining the distances.

### BRIEF DESCRIPTION OF THE DRAWINGS

FIG. 1 shows the contemplated system of two nodes which are connected to one another by a joint transmission channel.

FIG. 2 illustrates the quantization of a sequence of physical channel parameters.

### DETAILED DESCRIPTION OF THE INVENTION

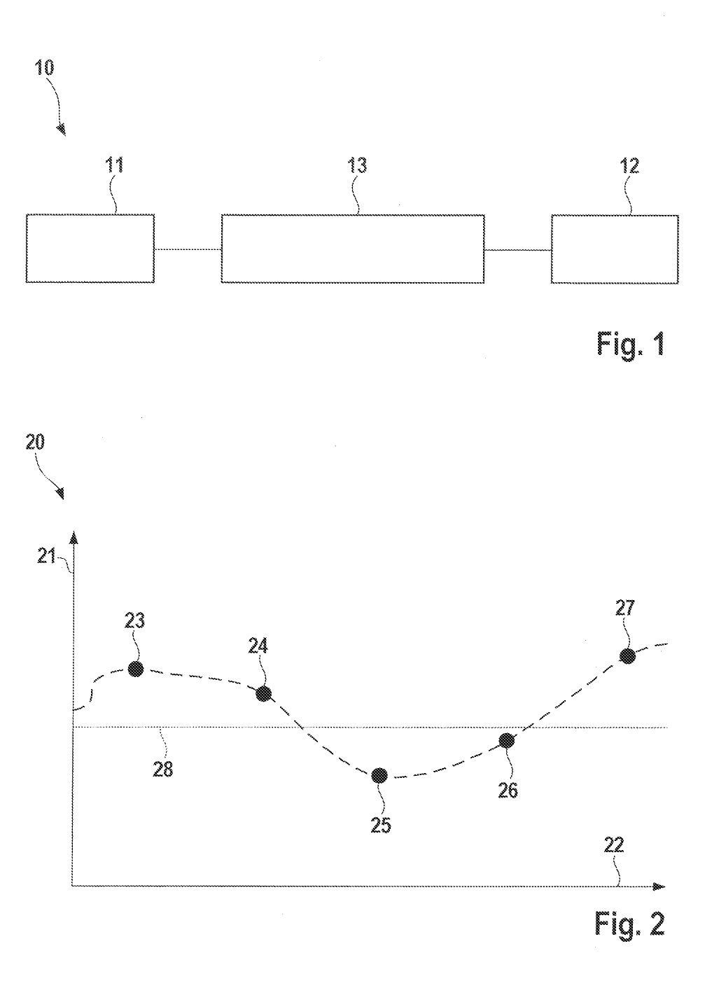

FIG. 1 illustrates system 10 underlying the present invention. Here, a first node 11 and a second node 12 communicate via a transmission channel 13 and generate symmetric cryptographic keys based on the suitable properties of this transmission channel 13. In this case, transmission channel 13 may be wireless, wired, or also optical in nature, a wireless transmission channel 13 being in particular contemplated in one advantageous embodiment of the present invention.

The basic method according to the present invention is generally subdivided into multiple steps, the first of which is now explained with reference to its progression over time 20 of FIG. 2. This step is used to estimate a physical channel parameter 21 of transmission channel 13 by way of a suitable measuring method. Several variables in principle come into consideration as channel parameters 21 such as the so-called “received signal strength indicators” (RSSI values) or the amplitude or phase of the instantaneous channel coefficient of transmission channel 13. This estimation may, for example, take place with the aid of suitable pilot signals which first node 11 or second node 12 transmits with the aid of transmission channel 13 to the respective other node.

Specifically, first node 11 and second node 12 each measure a sequence 23, 24, 25, 26, 27 of contemplated channel parameters 21 within a predefined time window 22; the time distance between two measurements maybe constant or may vary. Generally speaking, first node 11 thus receives a sequence of length N of estimated channel parameters x_{A}=(x_{A1}, x_{A2}, . . . , x_{AN}) and second node 12 receives a corresponding sequence x_{B}=(x_{B1}, x_{B2}, . . . , x_{BN}). Since first node 11 and second node 12 apply a matching decision threshold 28 for the quantization, it is important in this context that for i=1, . . . , N the ith channel parameter x_{Ai} of first node 11 generally has a high correlation with ith channel parameter x_{Bi} of second node 12. This may be ensured, for example, in that first node 11 and second node 12 estimate the ith channel parameter very quickly one after the other (in particular within a time period which is shorter than the coherence time of transmission channel 13) or in that the estimation is even carried out simultaneously, but within slightly different frequency ranges, the distance between the two frequency ranges then preferably being smaller than the coherence bandwidth of transmission channel 13.

In a second method step, first node 11 ascertains the distance between sequence x_{A} estimated by it and each entry of a known code book C including a total of M code words c₁, c₂, . . . , c_{M}. In this case, there are different ways to determine the distance. Concrete examples include the Euclidian distance, the Minkowski distance of order p, the chordal distance as well as the Chebyshev distance. Any other distance function may, however, in general also be used for this purpose.

Second node 12 carries out the same process initially independently of first node 11 and uses the same code book C and the same distance function d (x, y) for this purpose.

In a third method step, first node 11 and second node 12 ascertain independently of one another that particular code word c_{Ai} or C_{Bi}, respectively, which has the smallest distance (according to the used distance metric) from their respective sequence of channel parameters x_{A} or x_{B}, respectively:

$${c}_{{A}_{j}} = arg {min}_{{c}_{i} ∈ C} d ( {x}_{A} , {c}_{i} )$$

as well as

$${c}_{{B}_{j}} = arg {min}_{{c}_{i} ∈ C} d ( {x}_{B} , {c}_{i} )$$

Should there be multiple code words having the exact same distance, one of them is selected randomly.

Based on the precondition that the code book assigns a certain bit sequence to every code word, first node 11 and second node 12 ascertain this bit sequence for code words c_{Aj} and c_{Bj} determined by them and these bit sequences then form the basis for the actual initial bit sequence of first node 11 and second node 12. In the simplest case, these bit sequences are simply directly adopted as the initial bit sequences. The length of these bit sequences may be the same for each code word or it may vary.

Finally, the initial bit sequences are adjusted between first node 11 and second node 12 and optionally further processed. Appropriate approaches for these final method steps are sufficiently known to those skilled in the art. For this purpose, there is a plurality of approaches which are commonly referred to as “information reconciliation” processes. The adjustment may, for example, take place with the aid of error-correcting codes as well as a suitable communication protocol.

Based on this basic method, a plurality of other optimizations or alternatives is conceivable without departing from the scope of the present invention. For example, first node 11 and second node 12 may repeat the measuring of channel parameters 21, the determining of the distances, and the selecting of the code word multiple times. In a modification of this type, first node 11 and second node 12 thus do not determine their initial bit sequences in a single step, but contemplate multiple sequences of measured channel parameters 21 (referred to above as x_{A} and x_{B}) at the same time, the bit sequences assigned to each of the selected code words being linked to one another prior to the adjustment. A suitable link could, for example, be a simple concatenation of the partial sequences, but also a logical link, e.g., with the aid of an XOR function.

Code book C is preferably dynamically adapted to the existing ambient or boundary conditions in each case. For example, first node 11 or second node 12 could communicate to the other, respectively, what code book should be used in the further procedure. This could take place in such a way that there are several predefined code books and it must only be signaled which one of these code books is to be used. Alternatively thereto, the composition of the code book to be used may be signaled in detail (i.e., all code words including their assigned bit sequences). The selection of a suitable code book may, for example, take place as a function of the statistics of contemplated channel parameters 21. Thus, differently optimized code books might, for example, exist for scenarios with a strong line-of-sight component or without a line-of-sight component. In addition, different code books could also differ in size. In the case of devices having extremely limited resources, a smaller code book could, for example, be selected than in the case of more powerful devices.

In one alternative embodiment, first node 11 or second node 12 initially contemplates multiple distance metrics and ascertains for each of the contemplated metrics the distance from all code words in the code book to be used. Subsequently, a distance metric is selected and it is signaled to the other communication participant what metric is to be used. The latter communication participant then adopts the selection of the other participant. This may be advantageous, since a certain distance metric may be better suitable for a certain sequence of channel parameters x and a code book C than another distance metric, which, however, always depends on x and C.

As an expansion of the last named variant, first node 11 or second node 12 could also signal to the respective other node a list of potential distance metrics including the ascertained minimum distances from a code word from code book C, different code words being potentially optimal for different metrics. The other node may then also contemplate multiple distance metrics and ascertain therefor the minimum distances from a code word from code book C, and then ascertain based on its own results and on the list it received from the other participant what distance metric is optimal overall. This distance metric is then signaled to the other participant and used in the further procedure.

What is claimed is:

1. A method for generating a secret key, comprising:
measuring, by a first node which is connected via a transmission channel to a second node, a sequence of physical channel parameters of the transmission channel within a predefined time window;
determining, by the first node, for multiple predefined code words a distance of each code word from the sequence;
selecting, by the first node, from the multiple predefined code words, a code word which has the shortest distance from the sequence; and
adjusting, by at least the first node, a bit sequence which is assigned to the selected code word with the second node via the transmission channel.

2. The method as recited in claim 1, further comprising:
measuring, by the second node, the sequence of the physical channel parameters within the time window;
determining, by the second node, for the multiple predefined code words the distance of each code word from the sequence; and
selecting, by the second node, from the multiple predefined code words, the code word which has the shortest distance from the sequence;
wherein the first node and the second node jointly adjust the bit sequence.

3. The method as recited in claim 2, wherein:
the first node and the second node each store at least one matching code book which includes the multiple predefined code words and assigns the bit sequence to each code word.

4. The method as recited in claim 3, wherein the first node and the second node each store multiple sets of matching code books, and the first node and the second node select one set of matching code books from the multiple sets of matching code books prior to determining the distances.

5. The method as recited in claim 2, wherein the distance is determined with the aid of at least one of the following distance metrics: a Euclidian distance, a Minkowski distance of predefined order, a chordal distance, and a Chebyshev distance.

6. The method as recited in claim 5, wherein:
the distance of each code word is determined with the aid of multiple distance metrics;
a code word which has the shortest distance is selected for each distance metric; and
a distance metric is selected from the multiple distance metrics for which the selected code word has the shortest distance.

7. The method as recited in claim 2, wherein:
the measurement of the channel parameters, the determination of the distances and the selection of the code word are repeated multiple times; and
the bit sequences which are assigned to the code words selected in each case are linked to one another prior to the adjustment.

8. A system for generating a secret key, comprising:
a controller including a processor configured to:
measure a sequence of physical channel parameters of a transmission channel within a predefined time window;
determine for multiple predefined code words a distance of each code word from the sequence;
select from the code words a code word which has the shortest distance from the sequence; and
adjust a bit sequence which is assigned to the selected code word with the second node via the transmission channel.

9. A non-transitory, computer-readable memory medium storing a computer program having program codes which, when executed on a computer, perform a method for generating a secret key, the method comprising:
measuring a sequence of physical channel parameters of a transmission channel within a predefined time window;
determining for multiple predefined code words a distance of each code word from the sequence;
selecting from the multiple predefined code words, a code word which has the shortest distance from the sequence; and
adjusting a bit sequence which is assigned to the selected code word with the second node via the transmission channel.
